(19) United States
(12) Patent Application Publication
(10) Pub. No.: US 2002/0057152 A1
(43) Pub. Date: May 16, 2002

(54) Electronically controlled rotary fluid-knob as a haptical control element

(76) Inventors: Reinhold Elferich, Aachen (DE); Peter Luerkens, Aachen (DE)

Correspondence Address: Corporate Patent Counsel, U.S. Philips Corporation, 580 White Plains Road, Tarrytown, NY, 10591, US

(21) Appl. No.: 09/883,443

(22) Filed: Jun. 18, 2001

(30) Foreign Application Priority Data
Jun. 19, 2000 (DE) 10029191.0

(51) Int. Cl. H01F 7/08

(52) U.S. Cl. 335/220

(57) ABSTRACT

The present invention relates to a control element having a rotary knob (4), having a magnetic circuit and having at least one coil (1). The rotary knob (4) is supported so as to be rotatable with respect to at least a part of the magnetic circuit, the gap (5) present between the rotary knob (4) and the magnetic circuit is filled with a magnetorheologic fluid, and the coil (1) is arranged to exert a variable braking action on the rotary knob (4).

The invention relates to a control element having a rotary knob, having a magnetic circuit and having at least one coil.

The use of magnetic fluids is known from KR-A-950203 1. This concerns a rotary switch comprising a cylinder mounted on a rotatable shaft and filled with a magnetic fluid. The switch opens and closes an electrical contact by means of a rotational motion of the magnetic fluid, which is imparted to a lever.

It is an object of the invention to provide a control element that gives a haptical feedback response to the user. This haptical feedback response should range from a fixed stop via perceptible detent resistance to gentle vibrations. Moreover, the control element should consume minimal electric power.

According to the invention the object is achieved in that the rotary knob is supported so as to be rotatable with respect to at least a part of the magnetic circuit, the gap between the rotary knob and the magnetic circuit is filled with a magnetorheologic fluid, and the coil is arranged to exert a variable braking action on the rotary knob. The magnetic circuit surrounding the magnetorheologic fluid may comprise a single part or a plurality of parts. As a result of this, rotary knobs of different sizes can be realized in a simple manner. The rotary knob can be braked with different intensity and duration depending on whether a stop is to be simulated or a resistance is to be felt. The construction proves to be very robust, particularly in comparison with a conventional rotary knob driven by an electric motor via a transmission. Moreover, in spite of the transmission, the forces that can be exerted by an electric motor are many times smaller, as a result of which the user may readily overstep the simulated stop. Furthermore, an electric motor consumes distinctly more current, which prohibits its use in portable apparatuses such as mobile phones.

The embodiment as defined in claim 2 has the feature that it allows the use of thin-walled soft-magnetic parts, which reduces the overall volume and weight. Nevertheless, the radial magnetic field is powerful enough to change the viscosity of the magnetorheologic field in such a manner that the user can be given the impression of a stop which is unlikely to be overstepped.

The embodiment as defined in claim 3 prevents the magnetorheologic fluid from leaving the gap. To achieve this, it is necessary that the solid constituents in the fluid, such as metal particles, are kept away from the direct proximity of the bearing area because these would block the bearing and would cause braking effects, resulting in destruction of the bearing after a short period of operation. At the same time, a sealing element prevents the suspension substance of the fluid, which is generally water or oil, from escaping from the gap.

The embodiment as defined in claim 4 enables the rotary knob to be supported without any additional mechanical bearing means. The rotary knob then surrounds the non-movable stator in such a manner that the rotary knob cannot be pulled off the stator. The rotary knob this floats on the magnetorheologic fluid in the gap between the rotary knob and the stator, as a result of which a wear-free support is possible.

The embodiment as defined in claim 5 enables the rotary knob to be mounted on any electrical apparatus because it does not project into the housing and thus does not required any additional space in the interior of the apparatus.

The embodiments as defined in claims 6 and 7 enable the position of the rotary knob to be determined accurately. The use of the Hall sensors, through which a magnetic field is passed, the full range of rotation of 360° can be covered with satisfactory accuracy, the sensor also being capable of detecting the number of revolutions in the case that the angle of rotation is more than 360°. Moreover, the sensors operate in a contactless and therefore wear-free manner and can be integrated readily in the rotary knob. When the rotary knob has a push-button function in the axial direction, the same Hall sensors also enable a “depressed” or “non-depressed” condition to be detected, because the magnetic field through the Hall sensors differs in dependence on the push-button position.

Claims 8 through 11 define advantageous embodiments as regards the electronic control of the rotary knob. By means of such an electronic control it is possible to program a wide variety of feedback responses of the rotary knob. Depending on the use of the control element it can perform different functions and generate different feedback responses. Thus, the feeling of a stop can be obtained for a given angle of rotation so that this angle of rotation is not exceeded. For this purpose, an angle of rotation is programmed at which the coil of the rotary knob is energized so as to produce a strong braking action. For this purpose, the instantaneous angle of rotation detected via the Hall sensors is compared with the programmed angle of rotation of the stop position and when this position is reached the current for the coil is applied. Since the user can often turn the rotary knob slightly beyond the stop position with impetus and excessive force, a function is provided which immediately cancels the braking action of the rotary knob when this knob is turned in the opposite direction. Without this function a user would briefly have the impression that the rotary knob sticks because the braking action would not cease until arrival at the stop position. It is also possible to give the user the impression of the rotary knob being latched in that the rotary knob is braked briefly. Depending on the braking frequency this latching impression may change into vibrations.

The embodiments as defined in claims 12 and 13 relate to particularly advantageous fields of use of the rotary knob in accordance with the invention. Thus, the rotary knob is particularly suitable for controlling graphical user interfaces. At each menu item the user will notice a short click, which may be louder depending on the importance of the respective menu item. This is particularly important in motor vehicles because the driver can now operate the user interface blindly in that he relies exclusively on the haptical feedback response of the rotary knob. As a result, he need not take his eyes from the road, which adds to traffic safety. At the same time, this enables the number of controls and switches of a cockpit to be reduced considerably because the rotary knob can perform any number of functions. Moreover, the control element is also suitable for use in portables such a mobile phones because its current consumption is very low.

The user friendliness can be improved further by means of the embodiment as defined in claim 14. Thus, a synthesized voice can comment verbally on a menu item of the graphical user interface being reached by the rotary knob, thereby giving the driver an unambiguous and clear confirmation of the selected menu items.

Several embodiments of the invention will be described in more detail with reference to the drawings. In the drawings:

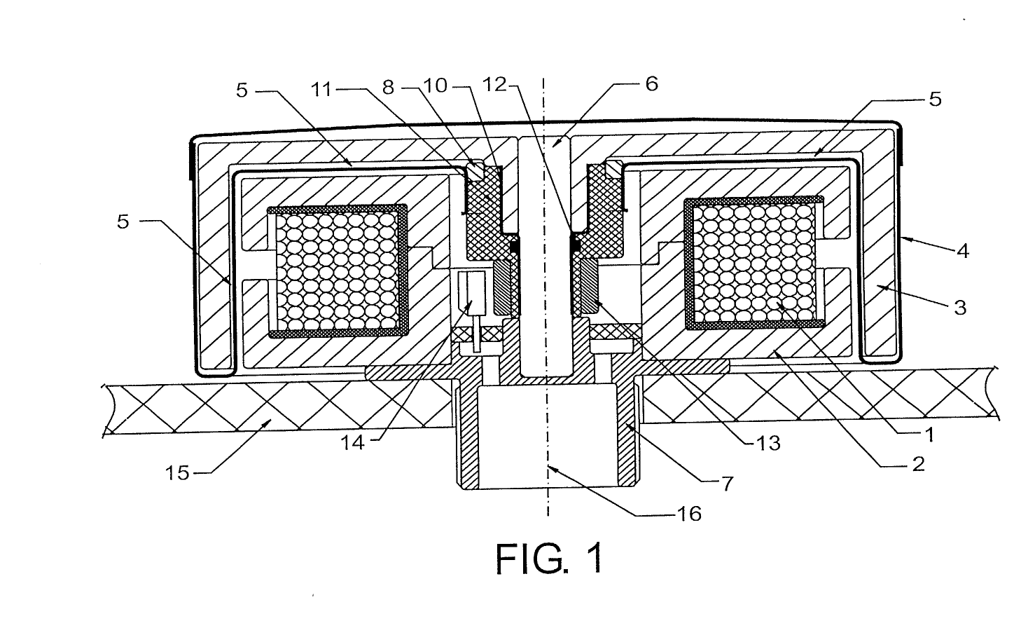

FIG. 1 shows a can-type rotary control for mounting in a housing wall,

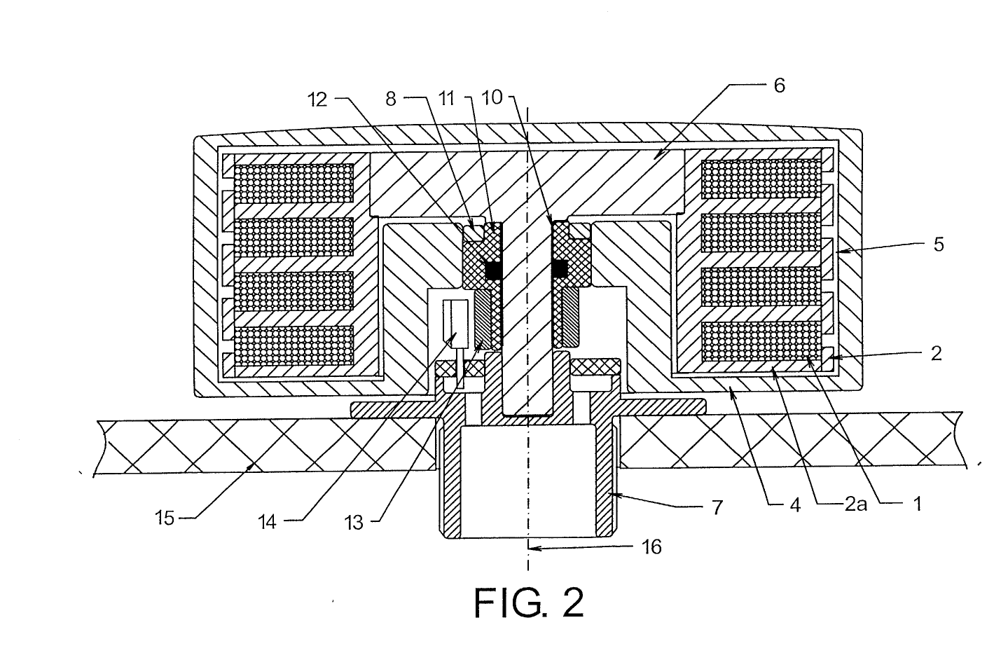

FIG. 2 shows a further rotary control,

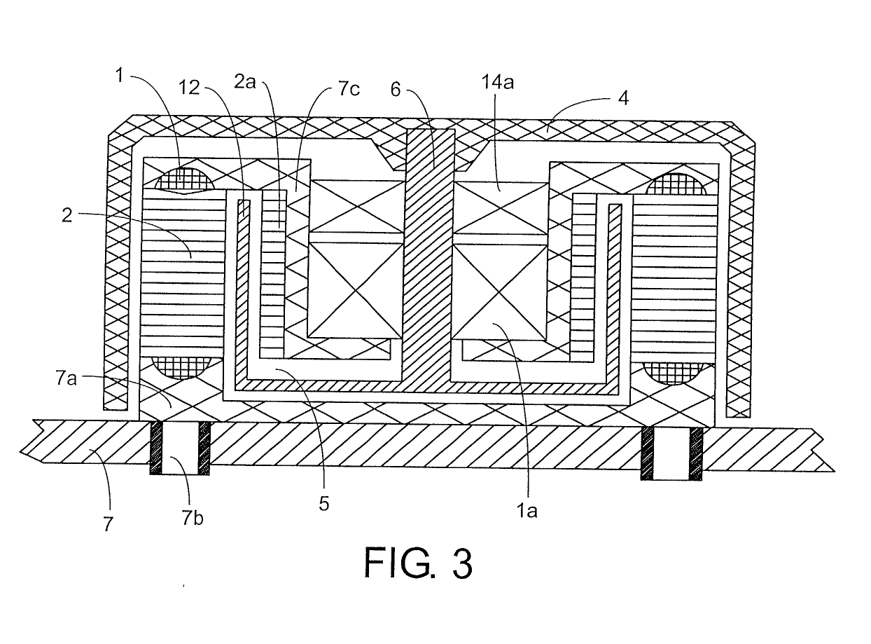

FIG. 3 shows a rotary control in a third embodiment,

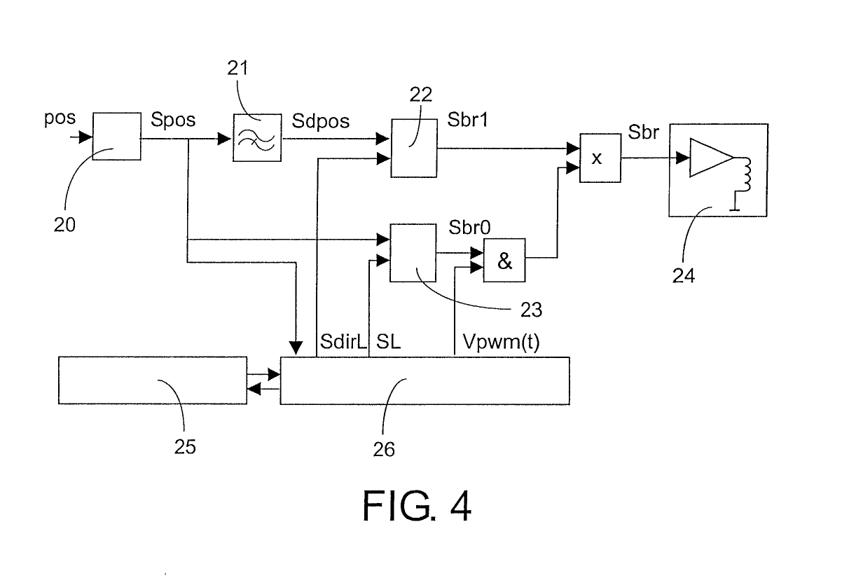

FIG. 4 shows the diagram of an algorithm for the simulation of a haptical stop,

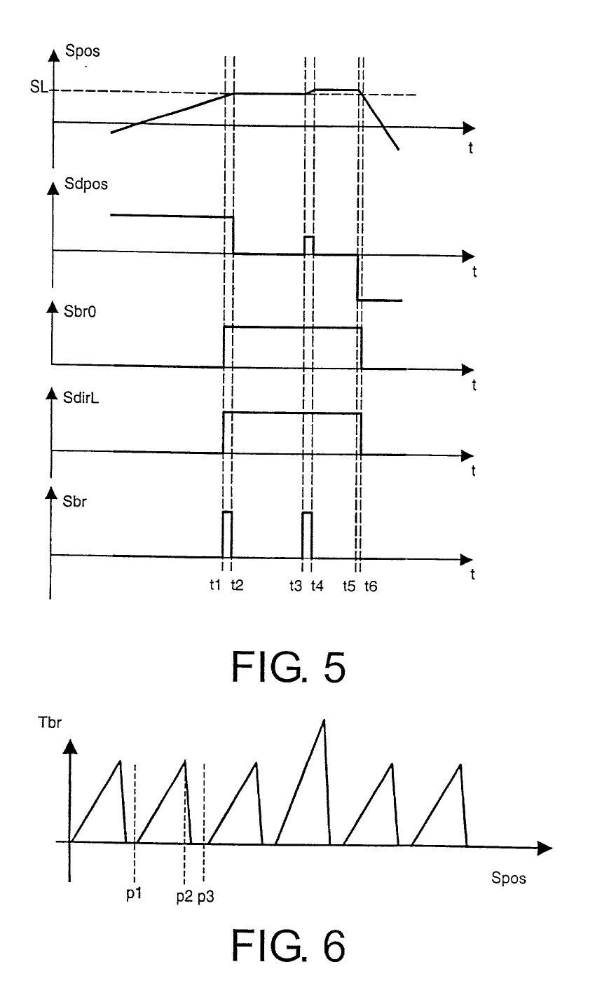

FIG. 5 shows waveforms of the signals processed by means of the algorithm, and

FIG. 6 shows the waveform of the position signal in the latching mode.

The can-type rotary control shown in FIG. 1 is intended for mounting in a housing wall 15. The control is essentially axially symmetrical with respect to an axis 16 and has a toroidal coil 1 accommodated in a soft-magnetic yoke ring 2, which generates a radial magnetic field in the area between its inner pole shoes and an outer soft-magnetic ring 3. Thus, the yoke ring 2 forms a magnetic circuit in combination with the soft-magnetic ring 3. The ring is fixedly connected to the yoke ring 2 via a shaft 6 and a base plate 7 and is not rotatable. Conversely, a thin-walled actuating wheel 4, which surrounds the ring 3, is rotatable. The actuating wheel 4 can be manufactured, for example, as a two-part deep-drawing product in the form of a can or a lid. The gap 5 between the ring 3 and the actuating wheel 4 is filled with a magnetorheologic fluid. A magnetorheologic fluid is to be understood to mean a fluid whose viscosity changes under the influence of a magnetic field. When the coil 1 is now energized the shear stress between the actuating wheel 4 and the fixed ring 3 increases, as a result of which a braking action is obtained.

The embodiment shown in FIG. 2 is also essentially symmetrical with respect to an axis 16. However, in the present case the actuating wheel 4, which serves as iron return ring, is a rotatable part of the magnetic circuit. The actuating wheel 4 surrounds the stationary arrangement of the yoke 2a, the coil 1 and a plurality of yoke rings 2. Again, a radial magnetic field is generated in the gap 5 between the yoke rings 2 and the actuating wheel 4. In this gap 5 a magnetorheologic fluid is present. In contradistinction to the arrangement shown in FIG. 1, the magnetic circuit has multiple poles along the axis 16, the winding direction changing from coil to coil. The multi-pole arrangement allows the wall thickness of the soft-magnetic parts to be reduced.

A two-part shaft seal is disposed in the gap 10. A ring 8 of a hard-magnetic material ensures that the tiny metal particles in the magnetorheologic fluid cannot reach the inner sealing and bearing area. Since in such fluids it is, in principle, possible that owing to the size of the metal particles a separation from the suspension substance (oil, water) may occur, a further sealing element 12 is used in order to retain the suspension substance. The magnetic sealing ring 8 and the sealing ring 12, which preferably consists of a plastic, are retained by a sealing holder 11, which further carries the movable part of angular-position sensor means. The sensor means carry out a magnetic position detection with the aid of two Hall sensors 14 and a magnetic sensor wheel 13. In order to achieve a continuous resolution for an angle of rotation of up to 360° the magnetic wheel 13 is magnetized transversely to its axis of rotation. The material of the wheel can be a cheap hard magnetic plastoferrite. The yoke rings 2 form the magnetic circuit return for the sensors 14. The Hall sensors 14 are fixedly connected to the base plate 7 and are again geometrically spaced apart by 90° about the axis 16. Analysis of the phase relationships of the sensor signals yields the position.

In a further embodiment the rotor 1a itself can also be magnetic and thus form the magnetic return. In this case, the return 2a may be dispensed with, while furthermore the desired shear effect is produced only at the outside of the rotor 1a. However, the gap 5 to be magnetized is then shorter. The rotor section 1a (in the instances described above) may alternatively be constructed as an external rotor. This means that the fluid gap 5 will be situated radially outside the stator section 2 carrying the armature winding 7.

In a further embodiment the actuating wheel 4 as well as the assembly 3, 8, 11, 13 are axially movable over a few millimeters with respect to the base plate 7, as a result of which a push-button function can be realized. The connection between the shaft 6 and the base plate 7 is then locked against rotation. The push-button function can now be detected by the same sensor means. For this purpose, the magnetic wheel 13 is axially arranged in such a manner that in the basic position it axially magnetizes the Hall sensors 14 only partly, while in the end position it is disposed wholly in the sensor area and consequently magnetizes the sensors 14 more strongly. The two combined movements can be analyzed independently of one another because the angle of rotation is detected via the phase relationship. In, for example, the Philips IC UZZ9000 this is effected with the aid of the CORDIC algorithm. This evaluates the two sensor signals as a point on a circular locus curve, for which it calculates the phase relationship. This relationship is independent of the amplitudes of the sensor signals over a wide range. This makes it possible to detect a movement in an axial direction without an additional sensor. With the present arrangement of sensors 14 and magnetic wheel 13 such a movement leads to a specific increase of the radius of the sensor signal locus curve, which can be determined easily.

FIG. 3 shows a rotary control having a laminated stator section 2 of a soft-magnetic material, which carries an armature winding 1 and which generates a radial magnetic field in a magnetically active gap 5 between the stator sections 2 and 2a . The stator section 2a also consists of a soft-magnetic material. A ring-shaped non-magnetic rotor 1a, connected to a bell-shaped actuating member 4, is disposed in the gap 5. Furthermore, a magnetically active fluid is present in the gap 5. The stator sections 2, 2a are connected to the housing/mounting wall 7 by means of a suitable mounting flange 7a. The electrical connections between the rotary control and the electronic control device are passed through sleeves 7b. The rotor la is supported relative to the stator 2 by appropriate means. In the area where the shaft 6 extends through the fluid container wall a suitable seal 12 is mounted. The position detection sensing process can take place in the area 14a. This construction makes it possible to dispense with conventional bearings because in this case the rotary knob 4 and the T-shaped shaft 6 secured thereto are supported in the magnetorheologic fluid. The shaft 6 cannot leave the gap 5 owing to the shape of this shaft.

In a further embodiment the coil 1 is not energized continuously during the clamping process but is clocked by a pulse generator PG by means of pulse width modulation (PWM). The PWM pattern is characterized by its frequency f and its duty cycle d. The frequency f then lies above the haptically relevant range (>1 kHz). Such a range also facilitates the detection of the direction of rotation because a torque applied to the rotary control leads to more pronounced microstep movements, as a result of which the sensitivity of the entire arrangement increases owing to the high-pass filter HF.

An algorithm for the haptical representation of a programmable stop will be described hereinafter with reference to FIG. 4. This algorithm can be realized in the form of a discrete circuit or a program run on a signal processor. The angular position pos of the rotor is converted into a signal Spos representative of an angle of rotation. A comparator 23 compares this signal with a reference signal SL supplied by an operational control unit 26. When the rotor position is in the stop range defined by SL the enable signal SbrO is produced. The magnitude of the braking force can be modulated, for example, via the duty cycle of a signal Vpwm(t). The braking signal Sbr energizes the armature winding 1 via a power amplifier 24.

If the braking process is controlled exclusively in this way, this will have the drawback that a continuous braking torque is applied, which will give the impression of sticking when the rotary knob is turned out of the stop position defined by SL. Therefore, a signal Sdpos, which corresponds to the change of the movement as a function of time, is derived from the position signal Spos by means of a high-pass filter 21. This signal is compared with a signal SdirL supplied via the movement control unit 26. When the two signals (Sdpos and SdirL) have the same sign and, in addition, the braking process has been enabled via SbrO, the armature winding 1 is energized and the braking process is thus started. The integration in the control of the apparatus is achieved via a connection to a higher-ranked application control unit 25, which selects the mode of operation (latching mode, braking mode) and evaluates the position settings.

The signal waveforms in FIG. 5 diagrammatically illustrate a braking process by way of example. At the instant t1 the position signal Spos reaches the stop range SL. Braking is effected because at the same time the direction of rotation Sdpos corresponds to the reference (positive in the present case). The rotor is rotated through a small angle beyond the reference value SL. The exact amount depends on the angular acceleration at the instant t1 and the braking current setting. At the instant t2 the rotor has come to a standstill. The braking current decreases. At the instant t3 a further movement against the stop takes place, which directly causes a re-energization of the armature winding. At the instant t4 the rotor is stationary. A movement away from the stop at the instant t5 does not lead to energization of the armature winding because the sign condition for Sdpos is not met. At the instant t6 the rotor again leaves the stop range.

FIG. 6 shows the signal waveform of Spos in the case that the rotary knob 4 is in the latching mode. For this, an essentially position-dependent braking action is produced. This braking function is stored in the electronic control device. Depending on the measured position signal Spos the armature coils 1 are energized in such a manner that the desired braking action of the rotary knob is produced. When the user turns the knob 4 this will give the user a feeling of an alternately positive and negative acceleration in the range between p2 and p3, Toothbrush being the applied torque and Spos being the angular position as above. In addition, the execution of the braking function may be programmed to be also dependent on the measured velocity of rotation of the knob 4 and its direction of rotation.

The control element in accordance with the invention is particularly suitable for controlling functions in the cockpit of automobiles or other means of conveyance. It can be used, for example, in conjunction with a navigation system, to control functions of this system. Since these systems generally include a speech synthesizer this can be used to comment verbally on a menu item of the graphical user interface being reached, thereby giving the user additional certainty as to the selected menu item.

1. A control element having a rotary knob (4), having a magnetic circuit and having at least one coil (1),
characterized in that
the rotary knob (4) is supported so as to be rotatable with respect to at least a part of the magnetic circuit, the gap (5) between the rotary knob (4) and the magnetic circuit is filled with a magnetorheologic fluid, and the coil (1) is arranged to exert a variable braking action on the rotary knob (4).

2. A control element as claimed in claim 1,
characterized in that
the magnetic field in the magnetorheologic fluid extends in a radial direction.

3. A control element as claimed in claim 1,
characterized in that
a ring (8) of a hard magnetic material has been provided to keep metal particles contained in the magnetorheologic fluid away from the bearing and sealing area (10), and a further sealing element (12) has been provided to ensure that the suspension substance of the magnetorheologic fluid remains in the gap (5).

4. A control element as claimed in claim 1,
characterized in that
the ring (8) of a hard material, in conjunction with the sealing element (12) and the magnetorheologic fluid in the gap (5), is adapted to perform the function of a bearing.

5. A control element as claimed in claim 1,
characterized in that
the entire mechanical structure and the required sensors (14) are accommodated in the interior of the rotary knob (4).

6. A control element as claimed in claim 1,
characterized in that
the control element includes Hall sensors (14) and a sensor magnet wheel (13) for determining the position of the rotary knob (4) with respect to the stationary part of the magnetic circuit.

7. A control element as claimed in claim 1,
characterized in that
the rotary knob (4) is adapted to perform a push-button function in an axial direction of its shaft (6), and the Hall sensors (14) and the sensor magnet wheel (13) are arranged in the control element in such a manner that, in addition to the angular position, they can detect the push-button function of the rotary knob (4).

8. A control element as claimed in claim 1,
characterized in that
an electronic circuit for driving the coil (1) has been provided, which circuit energizes the coil (1).

9. A control element as claimed in claim 8,
characterized in that
the electronic circuit is adapted to simulate the impression of a mechanical stop in dependence on the angle of rotation of the rotary knob (4).

10. A control element as claimed in claim 8,
characterized in that
the electronic circuit is adapted to control latching functions and other braking functions in dependence on the angle of rotation of the rotary knob (4) and of the time.

11. A control element as claimed in claim 9,
characterized in that
the electronic circuit controls the rotary knob (4) in such a manner that also after forcible turning far beyond the simulated stop the braking action of the rotary knob (4) is cancelled immediately in the case of rotation in the opposite direction.

12. A control element as claimed in claim 8,
characterized in that
the control element is adapted to control a graphical user interface.

13. A control element as claimed in claim 8,
characterized in that
the control element is adapted to perform the functions of conventional controls on electrical apparatuses.

14. A control element as claimed in claim 10,
characterized in that
the control element provides an additional feedback response in the form of synthesized speech when a menu item on the graphical user interface is reached.
